(19) United States
(12) Patent Application Publication
(10) Pub. No.: US 2020/0248548 A1
(43) Pub. Date: Aug. 6, 2020

(54) Systems and Methods for Monitoring Downhole Conditions

(71) Applicant: Saudi Arabian Oil Company, Dhahran (SA)

(72) Inventor: Abdulrahman Abdulaziz Al-Mulhem, Dhahran (SA)

(21) Appl. No.: 16/267,486

(22) Filed: Feb. 5, 2019

(51) Int. Cl. E21B 49/00; E21B 31/00; E21B 47/00; E21B 17/20; G01V 8/10; H02G 11/02; H01B 9/00; H01B 9/06

(52) U.S. Cl. CPC E21B 49/00; E21B 31/005; E21B 47/0002; E21B 17/20; E21B 2023/008; H02G 11/02; H01B 9/003; H01B 9/06; G01V 8/10

(57) ABSTRACT

A bottom hole assembly includes a well logging tool including a plurality of sensors, a vibrator tool coupled to the well logging tool for inserting the well logging tool into a wellbore, and a spoolable composite tube coupled to the vibrator tool, the spoolable composite tube configured to carry power and data cables from the surface to the plurality of sensors in the well logging tool. The well logging tool may further include one or more cameras installed on a distal end of the tool to provide a live visual means to check a well condition. A method for monitoring a well condition includes inserting a bottom hole assembly into a wellbore, and receiving, in real-time, data pertaining to the monitored well condition on the surface.

### BACKGROUND OF THE INVENTION

### 1. Field of the Invention

The present technology relates to oil and gas wells. In particular, the present technology relates to systems and methods for monitoring well conditions.

### 2. Description of the Related Art

Oil wells are typically examined to determine petrophysical properties related to one or more of the well bore, the reservoir it penetrates, and the adjacent formation. Such an examination is typically carried out by a well logging tool, which is lowered to the bottom of the well, and employs electrical, mechanical, and/or radioactive tools to measure and record certain physical parameters including pressure, temperature, flow rate, and other parameters. These parameters are normally interpreted to diagnose well and reservoir conditions. Several other factors pertaining to well conditions such as well architecture, depth, and oil grade are making it more difficult to acquire important data, and to make the best utilization of hydrocarbon assets.

Lowering the logging tool and other equipment (collectively known as the bottom hole assembly) to the bottom of the well can be difficult, particularly in horizontal or deviated portions of wells, where tubing is used to push the bottom hole assembly horizontally through the well bore. One reason for this difficulty is friction between the bottom hole assembly and walls of the well bore. The result of this friction can be that the bottom hole assembly stops progressing toward the bottom of the well. When the bottom hole assembly becomes stuck, the tubing that pushes the bottom hole assembly can buckle.

One known way to overcome this problem is with a well tractor that applies an urging force to the bottom hole assembly. A well tractor is typically a wheeled device that may be included with the bottom hole assembly. When the bottom hole assembly is pushed into the horizontal or deviated portion of the well, and if the friction between the bottom hole assembly and the well begins to slow or stop the progress of the bottom hole assembly toward the bottom of the well, the wheels on the well tractor may turn to drive the bottom hole assembly further into the well. Use of such a well tractor, however, can be problematic. For example, in reservoirs where the rock has low strength, insufficient traction may exist for the tractor to propel the bottom hole assembly toward the bottom of the hole. In addition, well tractors are expensive tools, and there are few companies that produce them.

### SUMMARY OF THE INVENTION

One example embodiment is a bottom hole assembly for monitoring well conditions. The bottom hole assembly includes a well logging tool including a plurality of sensors, a vibrator tool coupled to the well logging tool for inserting the well logging tool into a wellbore, and a spoolable composite tube coupled to the vibrator tool, the spoolable composite tube configured to carry power and data cables from the surface to the plurality of sensors in the well logging tool. The well logging tool may have a substantially cylindrical body comprising a matrix material. The plurality of sensors may be selected from the group consisting of acoustic sensors, optical sensors, mechanical sensors, electrical sensors, fluidic sensors, pressure sensors, temperature sensors, and chemical sensors. The well logging tool may further include one or more cameras installed on a distal end of the tool to provide a live visual means to check a well condition.

The spoolable composite tube may include a plurality of fibers embedded in the matrix material. The fibers may be woven, braided, knitted, stitched, circumferentially wound, or helically wound. The fibers may include at least one material selected from the group consisting of stainless steel, glass, carbon, ceramic, aramid, nylon, polyester, and polyethylene. The matrix material may be selected from the group consisting of polyether ether ketone, polyether ketone, polyetherketoneketone, polyamide, polyethylene, polyurethane, polypropylene, polyphenylene sulfide, epoxy, phenolic, bismaleimide, ester, polyester, vinyl-ester, ceramic, and carbon. The matrix material may have a tensile modulus of elasticity of at least 250,000 psi, has a maximum tensile elongation of greater than or equal to 5%, or has a glass transition temperature of at least 180 degrees F.

The vibrator tool may include a substantially cylindrical body, a motor within the substantially cylindrical body, a non-linear shaft attached to the motor so that as the motor turns the non-linear shaft, the non-linear shaft extends outwardly from the motor within the substantially cylindrical body, and a bearing attached to the shaft a distance from the motor so that the bearing rotates as the non-linear shaft turns, the bearing contacting portions of the inner surface of the cylindrical body as the non-linear shaft turns, thereby vibrating the substantially cylindrical body. The motor is able to turn the shaft at a rate of about 1000-2000 revolutions per minute. The substantially cylindrical body has longitudinal slots that are positioned to contact the bearing as the bearing rotates so that contact between the bearing and the slots amplifies the vibration of the vibrator tool.

Another example embodiment is a method for monitoring a well condition. The method includes inserting a bottom hole assembly into a wellbore, and receiving, in real-time, data pertaining to the monitored well condition on the surface. The bottom hole assembly in this embodiment may include a well logging tool including a plurality of sensors for monitoring a well condition, a vibrator tool for enabling insertion of the well logging tool into the wellbore, and a spoolable composite tube to carry power and data cables from the surface to the plurality of sensors in the well logging tool. The method further includes the steps of lowering the bottom hole assembly through a vertical part of the well, pushing the bottom hole assembly through a deviated part of the well using the tubing, and vibrating the bottom hole assembly and tubing with the vibrating tool to reduce friction between the bottom hole assembly and tubing, and the wellbore.

In some embodiments, the bottom hole assembly can include more than one vibrating tool. In addition, the method can include one or more of the steps of adjusting the distance of the bearing from the motor to increase or decrease vibration, and adjusting the weight of the bearing to increase or decrease vibration.

Another example embodiment is a system for monitoring a well condition. The system includes a well logging tool including a plurality of sensors, a vibrator tool coupled to the well logging tool to enable inserting the well logging tool into a wellbore, and a spoolable composite tube coupled to the vibrator tool, the spoolable composite tube configured to carry power and data cables from the surface to the plurality of sensors in the well logging tool. The well logging tool may have a substantially cylindrical body comprising a matrix material. The plurality of sensors may be selected from the group consisting of acoustic sensors, optical sensors, mechanical sensors, electrical sensors, fluidic sensors, pressure sensors, temperature sensors, and chemical sensors. The well logging tool may also include one or more cameras installed on a distal end of the tool to provide a live visual means to check a well condition. The spoolable composite tube may include a plurality of fibers embedded in the matrix material. The matrix material may have a tensile modulus of elasticity of at least 250,000 psi, has a maximum tensile elongation of greater than or equal to 5%, or has a glass transition temperature of at least 180 degrees F.

### BRIEF DESCRIPTION OF THE DRAWINGS

The present technology will be better understood on reading the following detailed description of non-limiting embodiments, and on examining the accompanying drawings, in which:

FIG. 1 is a schematic side view of an oil well having a bottom hole assembly inserted therein, according to an embodiment of the present technology;

FIG. 2 is a schematic side view of the deviated portion of a well bore having a bottom hole assembly with a well tractor inserted therein, according to an embodiment of the present technology;

FIG. 3 is a schematic side view of the deviated portion of a well bore having a bottom hole assembly with a vibrator sub tool inserted therein, according to an embodiment of the present technology;

FIG. 4 is a schematic view of a bottom hole assembly with a well logging tool, a vibrator sub tool, and a spoolable composite tube, according to an embodiment of the present technology;

FIG. 5 is a schematic view of a bottom hole assembly with a well logging tool having a plurality of sensors and a camera, a vibrator sub tool, and a spoolable composite tube, according to an embodiment of the present technology;

FIG. 6 is a perspective view of a gear and weight of a vibrator tool, according to an embodiment of the present technology;

FIG. 7 is a perspective view of a vibrator sub tool, according to another embodiment of the present technology;

FIG. 8 is a cross-sectional view of a composite tubular member includes a liner, a composite layer, an energy conductor, and a sensor, according to another embodiment of the present technology;

FIG. 9 is a side view of a flattened out composite layer that has triaxially braided fiber components and which is suitable for constructing the composite layer of the composite tube, according to another embodiment of the present technology;

FIG. 10 is a cross-sectional view of a composite tubular member having multiple energy conductors and multiple sensors, according to another embodiment of the present technology;

FIG. 11 is a cross-sectional view of the composite tubular member of FIG. 8 having a second energy conductor helically oriented and connected to a second sensor, according to another embodiment of the present technology; and

FIG. 12 illustrates the composite tubular member of FIG. 8 connected to a signal processor, according to another embodiment of the present technology.

### DETAILED DESCRIPTION OF THE EXEMPLARY EMBODIMENTS

The foregoing aspects, features, and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. However, the embodiments are not intended to be limited to the specific terms used, and it is to be understood that each specific term includes equivalents that operate in a similar manner to accomplish a similar purpose.

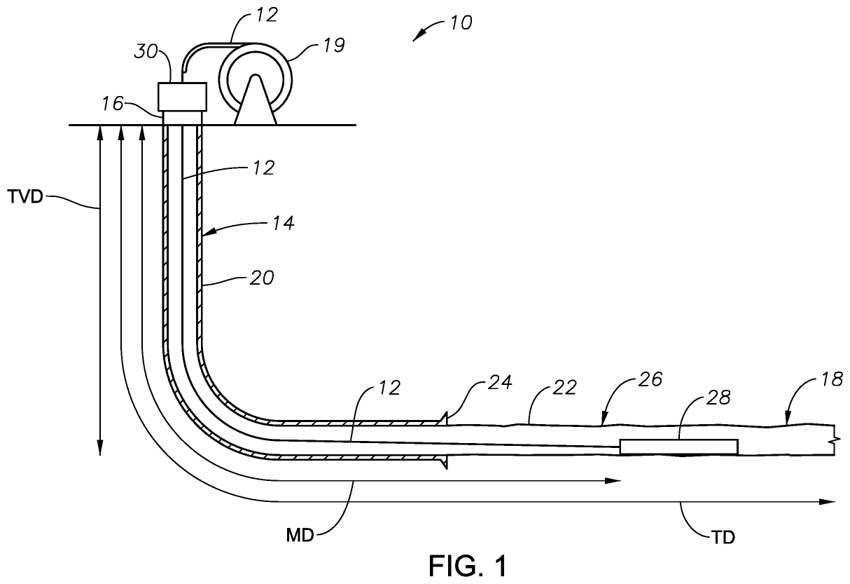

FIG. 1 shows a schematic view of an example of a well logging assembly 10. The well logging assembly 10 of FIG. 1 includes tubing 12 that extends through a well 14 from the wellhead 16 toward the bottom of the well 18. Prior to entry into the well 14, the tubing 12 is coiled around a coiled tubing reel 19. The well 14 can include a vertical section 20 and a horizontal or deviated section 22. The length of the vertical section 20 of the well 14 is known as the true vertical depth TVD, and the length of the well 14 from the wellhead 16 to the bottom of the well 18 is known as the total well depth TD. Typically, the well 14 is cased with a casing (not shown) that extends along a substantial portion of the wellbore from the wellhead downward, terminating at a casing shoe 24. Below the casing shoe 24 is an open hole section 26 of the well 14.

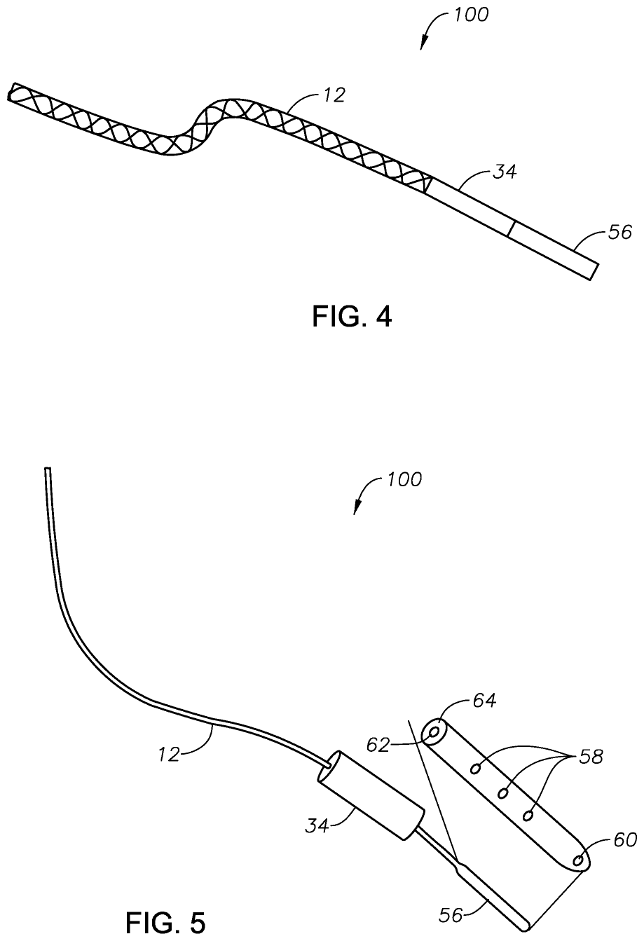

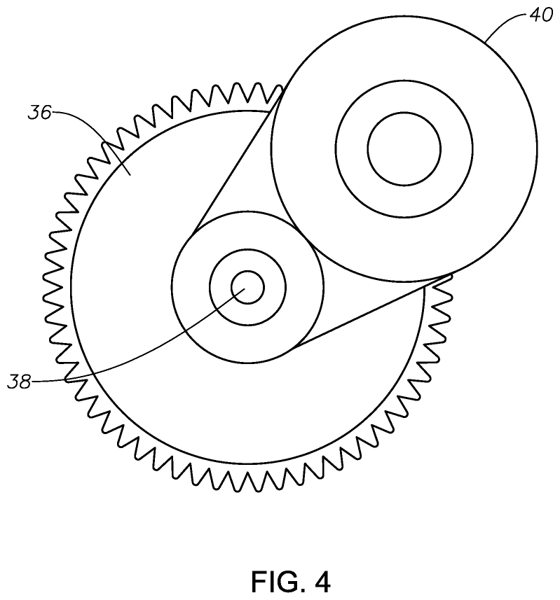

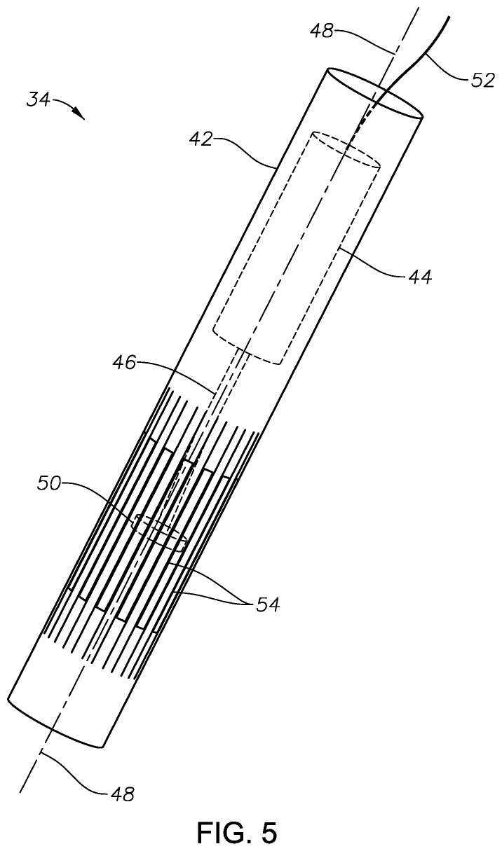

There is attached to the end of the tubing 12 a bottom hole assembly 28, which, in the embodiment shown in FIG. 1, includes a well logging tool. The well logging tool can include mechanical, electrical, and/or radioactive equipment to record physical measurements that are then interpreted to provide a description of the petrophysical properties of the wellbore, the reservoir, and/or the formation. The well logging tool is described in further detail in FIGS. 4 and 5. The length of the well 14 from the wellhead 16 to the bottom hole assembly 28 is known as the measured depth MD.

As the tubing 12 is unwound from the coiled tubing reel 19, the bottom hole assembly 28 is lowered into the well 14. In the vertical portion 20 of the well 14, the weight of the bottom hole assembly 28 pulls the bottom hole assembly 28 and its attached tubing 12 into the well 14. In wells having no deviated portion, the weight of the bottom hole assembly 28 alone may be sufficient to bring the bottom hole assembly 28 to the bottom 18 of the well 14. However, in wells having a horizontal or deviated portion 22, the coiled tubing 12 typically pushes the bottom hole assembly 28 further into the well 14 to move the bottom hole assembly 28 through the horizontal or deviated portion 22 of the well 14. Typically, an injector 30 can be included to force the tubing 12 into the well once the bottom hole assembly 28 reaches the horizontal or deviated portion 22 of the well 14.

As the bottom hole assembly 28 and the end of the tube 12 progress through the horizontal or deviated portion 22 of the well 14, friction can develop between the bottom hole assembly 28 and the walls of the well 14. As friction between these components increases, the injector 30 must exert more and more force on the tubing 12 to continue pushing the bottom hole assembly 28 deeper into the well 14. If the frictional forces between the bottom hole assembly 28 and the walls of the well 14 become greater than the force exerted on the tubing by the injector 30, forward progress of the bottom hole assembly 28 into the well 14 can slow or stop. In this situation, the bottom hole assembly 28, including the logging tool 29, cannot reach the bottom of the well 18 to record the required measurements. In addition, such a situation can lead to the tubing 12 buckling as the bottom hole assembly 28 stops progressing at the same rate as the tubing 12.

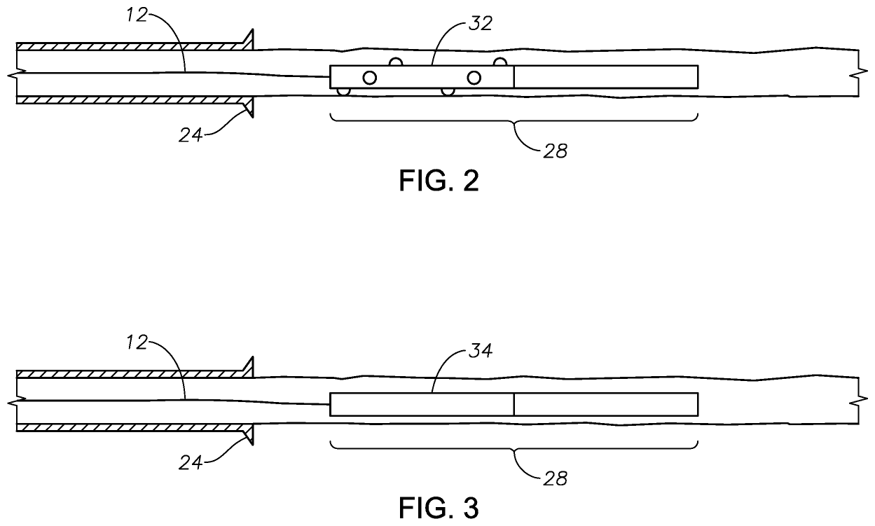

As shown in FIG. 2, to overcome the problem of buckled tubing 12, and to help the bottom hole assembly 28 progress down the well 14, a well tractor 32 can be included in the bottom hole assembly 28. The well tractor 32 is a piece of equipment attached to the logging tool and the tubing, and having wheels that can engage the surface of the well 14. The wheels can be powered by, for example, hydraulics. As the wheels of the well tractor 32 turn, the well tractor 32 can push the rest of the bottom hole assembly 28 further downhole. One disadvantage to the well tractor 32, however, is that where the reservoir rock in the open hole section 26 has low strength, it is possible that the well tractor wheels cannot obtain adequate traction in the soft formation to push the bottom hole assembly 28 further into the well 14.

Referring now to FIG. 3, there is shown an embodiment of the present technology in which a vibrating sub tool 34 is included in the down hole assembly 28 to help the bottom hole assembly 28 progress down a well 14. The vibrating sub tool 34 can help the bottom hole assembly 28 to progress in situations where, for example, the frictional forces between the bottom hole assembly 28 or tubing 12 and the well 14 are greater than the forces exerted on the tubing 12 by the injector 30, as discussed above.

The vibrating sub tool 34 is a tool that can produce vibration. This vibration can be manifested in the shaking or agitation of the vibrating sub tool 34 relative to the well 14, and has the tendency to cause the vibrating sub tool 34 to rapidly move or oscillate relative to the well 14, thereby decreasing contact and, as a result, frictional forces, between the vibrating sub tool 34 and the well 14. In some embodiments, the vibration can be enough to separate the vibrating sub tool 34 from surfaces of the well. This vibration can in turn provide vibration or agitation to the bottom hole assembly 28 and tubing 12, thereby reducing frictional forces between the bottom hole assembly 28 and tubing 12, and the well 14 in the same way. When the frictional forces are less than the forces exerted on the bottom hole assembly 28 by the injector 30 and the tubing 12, the down hole assembly 28 can continue to move down hole. If desired, multiple vibration sub tools 34 can be deployed in the same well 14, thereby increasing the amount of vibration and further reducing friction between the bottom hole assembly 28 and tubing 12, and the well 14.

FIG. 4 illustrates a system 100 for monitoring a well condition, according to some embodiments. The system includes a well logging tool 56, a vibrator sub tool 34, and the tubing 12 for carrying power and data cables. FIG. 5 shows a cross-sectional view of the well logging tool 56, which includes a plurality of sensors 58 and one or more cameras 60 for live viewing of the well conditions from the surface. As illustrated, the well logging tool 56 may have a substantially cylindrical body made of a matrix material 64. The matrix material may be selected from the group consisting of polyether ether ketone, polyether ketone, polyetherketoneketone, polyamide, polyethylene, polyurethane, polypropylene, polyphenylene sulfide, epoxy, phenolic, bismaleimide, ester, polyester, vinyl-ester, ceramic, and carbon. The matrix material may have a tensile modulus of elasticity of at least 250,000 psi, has a maximum tensile elongation of greater than or equal to 5%, and has a glass transition temperature of at least 180 degrees F. In one example embodiment, the preferred matrix material may be polyether ether ketone (PEEK), and the well logging tool may have a diameter of approximately 0.5 to 1.0 inch. The data and power cables 62 may be installed in the core of the PEEK structure.

The well logging tool 56 can be equipped with two or more sensors 58 in a distal end section of the well logging tool 56, for example, in the last 10-20 ft of the tool 56. The plurality of sensors 58 may be selected from the group consisting of acoustic sensors, optical sensors, mechanical sensors, electrical sensors, fluidic sensors, pressure sensors, temperature sensors, and chemical sensors. Although only three sensors are illustrated, the system 100 may include one or more of each type of sensors listed here. For example, the optical sensor can be an interferometric sensor or an optical intensity sensor. The optical intensity sensor may include light scattering sensors, spectral transmission sensor, radiative loss sensors, reflectance sensors, and modal change sensors. The mechanical sensor may include piezoelectric sensors, vibration sensors, position sensors, velocity sensors, strain sensors, and acceleration sensors. The electrical may include current sensors, voltages sensors, resistivity sensors, electric field sensors, and magnetic field sensors. The fluidic sensor may include flow rate sensors, fluidic intensity sensors, and fluidic density sensors. The pressure sensor may include absolute pressure sensors and differential pressure sensors. The temperature sensor may include thermocouples, resistance thermometers, and optical pyrometers. The well logging tool 56 may further include one or more cameras 60 that may be installed on a distal end of the tool 56 to provide a live visual means to check a well condition.

Vibration of the vibrating sub tool 34 can be caused by a motor, which, in one possible embodiment, can be structured in a similar way to the arrangement shown in FIG. 6. In FIG. 6, there is shown an arrangement in which a motor (not shown) drives a gear 36 with a motor shaft 38. A weight 40 is attached to the gear 36 in a position off-center from the center of the gear 36. When the motor spins the gear 36 at a high rate of speed, the off-center weight 40 causes a vibration. The magnitude of this vibration can be controlled by adjusting the size of the weight 40, or the position of the weight 40 relative to the gear 36 and the shaft 38.

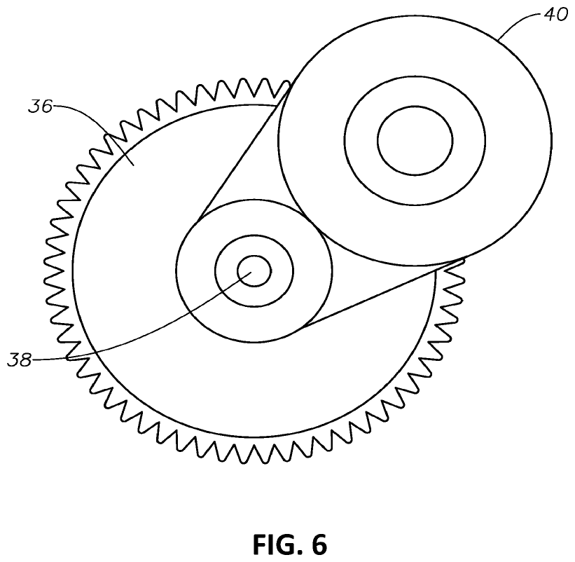

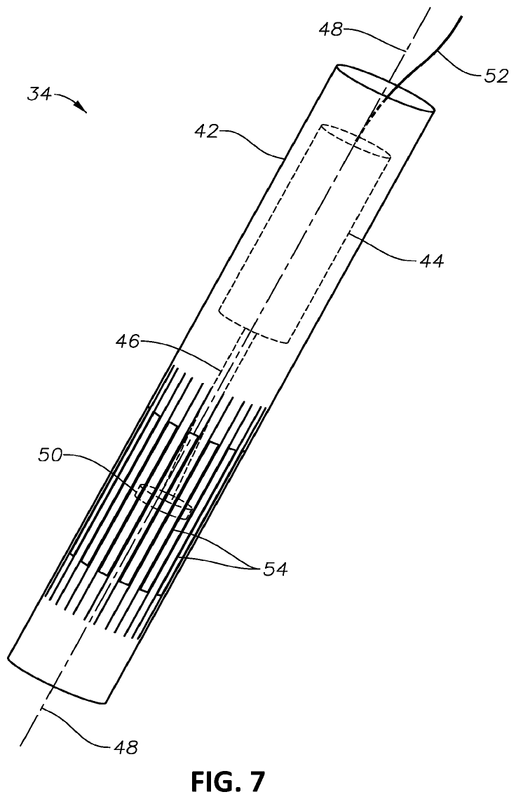

Another embodiment of the vibrating sub tool 34 is shown in FIG. 7. In this embodiment, the vibrating sub tool 34 has a body 42 that encloses an electric motor 44 having a shaft 46 extending therefrom. The shaft 46 is not straight, but is curved or bent relative to a longitudinal axis 48 of the body 42. A bearing 50 can be attached to the end of the shaft 46, and can connect the shaft 46 to the body 42. Because the shaft 46 is curved or bent, the bearing 50 is off-center from the longitudinal axis 48. The motor 44 can be connected to an electric cable 52 that provides power to the motor 44 so that the motor 44 can turn the shaft 46. In practice, the motor 44 turns the shaft 46, which in turn rotates the bearing 50 around the inside of the body 42. The bearing 50 can contact the inside surfaces of the body 42, thereby increasing the vibration of the vibrating sub tool 34. In one example embodiment, the motor 34 rotates the shaft at a rate of about 1000-2000 revolutions per minute (rpm). Because the bearing 50 is off center, the rotating of the bearing 50 causes the body 42 to vibrate.

The embodiment of FIG. 7 can also include one or more vibrating slots 54, positioned circumferentially at intervals around the body 42. The vibrating slots 54 can be positioned adjacent the bearing 50, so that as the shaft 46 and bearing 50 rotate, the bearing contacts the vibrating slots 54. The vibrating slots 54 can be created by cutting the body 42 longitudinally at intervals around the circumference of the body 42. Alternatively, the vibrating slots 54 can be created by cutting away and removing portions of the body 42. Thus configured, contact between the bearing 50 and the vibrating slots 54 will cause the remaining portions of the body 42 adjacent the slots 54 to vibrate at a greater amplitude than the rest of the body 42, thereby amplifying the vibration of the body 42, and increasing the vibration of the vibrating sub tool 34 as a whole. As discussed above, vibration of the vibrating sub tool 34 leads to vibration of the coiled tubing 12 and other components of the bottom hole assembly 28.

Use of a vibration sub tool 34 to reduce friction between the tubing 12, bottom hole assembly 28, and the well 14 can be advantageous compared to the well tractor 32, because the vibrating sub tool 34 has few parts and can be manufactured and installed more economically. In addition, the vibration sub tool 34 has the ability to move the bottom hole assembly 28 even when the reservoir rock is of low strength, a condition that could preclude the use of a well tractor 32.

In practice, the vibrating sub tool 34 of the present technology can be used according to the following method. Initially, the bottom hole assembly 28, including the vibrating sub tool 34, can be lowered into the well 14. As the bottom hole assembly 28 passes through the vertical section 20 of the well 14, the weight of the bottom hole assembly itself can pull the bottom hole assembly 28 downward toward the bottom 18 of the well 14. Upon reaching the horizontal or deviated section 22 of the well 14, the tubing 12 attached to the bottom hole assembly 28 can begin pushing the bottom hole assembly 28 horizontally through the well 14. If desired, such as when the frictional forces between the bottom hole assembly 28 and the well 14 exceed the force exerted on the bottom hole assembly 28 by the tubing 12, the vibrating sub tool 34 may be activated and begin to vibrate. This vibration can agitate the bottom hole assembly 28 and tubing 12, thereby reducing the amount of friction between the tubing 12, bottom hole assembly 28, and the well 14 so that the tubing 12 can continue to push the bottom hole assembly 28 toward the bottom 18 of the well 14.

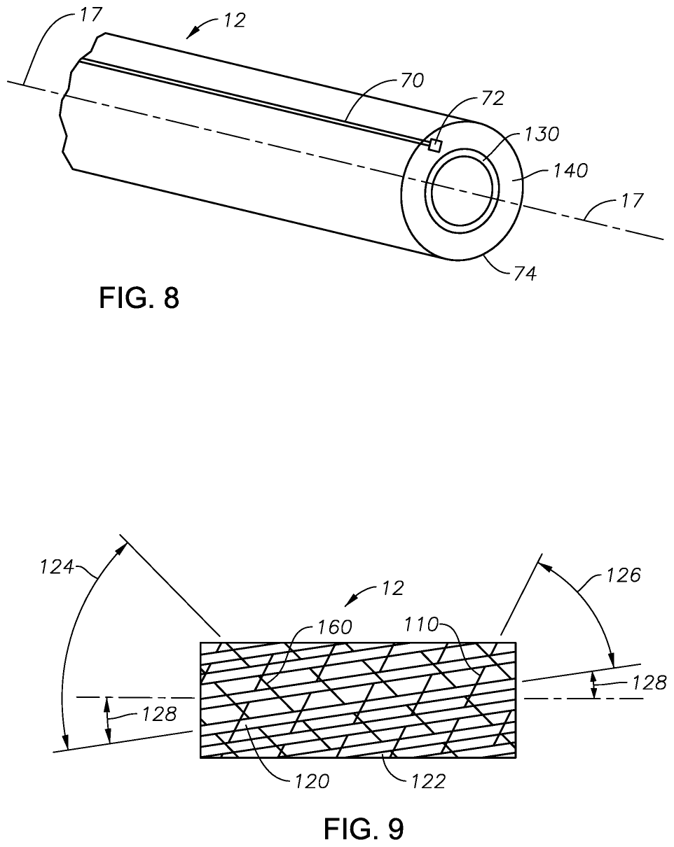

FIG. 8 illustrates a composite tube 12 constructed of a substantially fluid impervious pressure barrier 130 and a composite layer 140. The composite coiled tube is generally formed as a member elongated along axis 17. The coiled tube can have a variety of tubular cross-sectional shapes, including circular, oval, rectangular, square, polygonal and the like. The illustrated tube has a substantially circular cross-section. The composite tube also includes an energy conductor 70 extending lengthwise along the tubular member, and a sensor 72 mounted with the tubular member.

The sensor 72 is a structure that senses either the absolute value or a change in value of a physical quantity. Exemplary sensors for identifying physical characteristics include acoustic sensors, optical sensors, mechanical sensors, electrical sensors, fluidic sensors, pressure sensors, temperature sensors, strain sensors, and chemical sensors.

Mechanical sensors suitable for deployment in the composite tubular member 12 include piezoelectric sensors, vibration sensors, position sensors, velocity sensors, strain gauges, and acceleration sensors. The sensor 72 can also be selected from those electrical sensors, such as current sensors, voltage sensors, resistivity sensors, electric field sensors, and magnetic field sensors. Fluidic sensors appropriate for selection as the sensor 72 include flow rate sensors, fluidic intensity sensors, and fluidic density sensors. Additionally, the sensor 72 can be selected to be a pressure sensor, such as an absolute pressure sensor or a differential pressure sensor. For example, the sensor 72 can be a semiconductor pressure sensor having a moveable diaphragm with piezoresistors mounted thereon.

The sensor 72 can be also selected to be a temperature sensor. Temperature sensors include thermocouples, resistance thermometers, and optical pyrometers. A thermocouple makes use of the fact that junctions between dissimilar metals or alloys in an electrical circuit give rise to a voltage if they are at different temperatures. The resistance thermometer consists of a coil of fine wire. Copper wires lead from the fine wire to a resistance measuring device. As the temperature varies the resistance in the coil of fine wire changes.

FIG. 8 also illustrates an energy conductor connected to the sensor 72 and embedded in the composite tubular member. The energy conductor 70 can be either a hydraulic medium, a pneumatic medium, an electrical medium, an optical medium, or any material or substance capable of being modulated with data signals or power. For example, the energy conductor can be a fluid impermeable tube for conducting hydraulic or pneumatic energy along the length of the composite tube. The hydraulic or pneumatic energy can be used to control or power the operation of a machine, such as activating a valve, operably coupled to the composite tube. Alternatively, the energy conductor can be an electrically conductive medium, such as copper wire, for transmitting control, data, or power signals to an apparatus operably coupled to the composite tube. The energy conductor can also be selected from optical medium, such as fiber optics, for transmitting an optical signal along the composite tube. Different types of fiber optics, such as single-mode fibers, multimode fibers, or plastic fibers, may be more suited depending upon the type of sensor 72 that is connected to the conductor 70. The composite tube can include one or more of the described energy conductors.

As further illustrated in FIG. 8, the composite layer 140 and the pressure barrier 130 constitute a wall 74 of the tubular member 10. The energy conductor 70 is embedded within the wall 74, and the sensor 72 is mounted with the wall 74 of the tubular member. The sensor is connected with the energy conductor such that a signal generated by the sensor can be communicated by way of the energy conductor 70. For instance, the sensor 72 can generate a signal responsive to an ambient condition of the tubular member 12 and the sensor can communicate this signal on the energy conductor 70.

In one example embodiment, the spoolable composite tube 12 may include a plurality of fibers embedded in the matrix material. The fibers may be woven, braided, knitted, stitched, circumferentially wound, or helically wound. The fibers may include at least one material selected from the group consisting of stainless steel, glass, carbon, ceramic, aramid, nylon, polyester, and polyethylene. The matrix material may be selected from the group consisting of polyether ether ketone, polyether ketone, polyetherketoneketone, polyamide, polyethylene, polyurethane, polypropylene, polyphenylene sulfide, epoxy, phenolic, bismaleimide, ester, polyester, vinyl-ester, ceramic, and carbon. The matrix material may have a tensile modulus of elasticity of at least 250,000 psi, a maximum tensile elongation of greater than or equal to 5%, and have a glass transition temperature of at least 180 degrees F.

In other embodiments of pressure barrier layer 130, the pressure barrier layer comprises co-polymers formed to achieve enhanced pressure barrier layer characteristics, such as corrosion resistance, wear resistance and electrical resistance. For instance, a pressure barrier layer 130 can be formed of a polymer and an additive such that the pressure barrier layer has a high electrical resistance or such that the pressure barrier layer dissipates static charge buildup within the composite tube 12. In particular, carbon black can be added to a polymeric material to form a pressure carrier layer 130 having a resistivity on the order of 10⁸ ohms/centimeter. Accordingly, the carbon black additive forms a pressure barrier layer 130 having an increased electrical conductivity that provides a static discharge capability. The static discharge capability advantageously prevents the ignition of flammable fluids being circulated within the composite coiled tube 12.

In a further aspect, the pressure barrier layer 130 has a mechanical elongation of at least 25%. A pressure barrier layer with a mechanical elongation of at least 25% can withstand the increased bending and stretching strains placed upon the pressure barrier layer as it is coiled onto a reel and inserted into and removed from various well bores. Accordingly, the mechanical elongation characteristics of the pressure barrier layer prolong the overall life of the composite coiled tube 10. In addition, the pressure barrier layer 130 preferably has a melt temperature of at least 250 degrees Fahrenheit so that the pressure barrier layer is not altered or changed during the manufacturing process for forming the composite coiled tubing. A pressure barrier layer having these characteristics typically has a radial thickness in the range of 0.02-0.25 inches.

The composite layer 140 can be formed of a number of plies, each ply having fibers disposed with a matrix, such as a polymer, resin, or thermoplastic. Preferably, the matrix has a tensile modulus of at least 250,000 psi and has a maximum tensile elongation of at least 5% and has a glass transition temperature of at least 180 Degrees Fahrenheit. The fibers typically comprise structural fibers and flexible yarn components. The structural fibers are formed of either carbon, nylon, polyester, aramid, thermoplastic, or glass. The flexible yarn components, or braiding fibers, are formed of either nylon, polyester, aramid, thermoplastic, or glass. The fibers included in layer 14 can be woven, braided, knitted, stitched, circumferentially wound, or helically wound. In particular, the fibers can be biaxially or triaxially braided. The composite layer 140 can be formed through pultrusion processes, braiding processes, or continuous filament winding processes. A tube formed of the pressure barrier layer 130 and the composite layer 140 form a composite tube has a tensile strain of at least 0.25 percent and being capable of maintaining an open bore configuration while being spooled on a reel.

The pressure barrier layer 130, illustrated in FIG. 8, can also include grooves or channels on the exterior surface of the pressure barrier layer. The grooves increase the bonding strength between the pressure barrier layer 130 and the composite layer 140 by supplying a roughened surface for the fibers in the composite layer 140 to latch onto. The grooves can further increase the bonding strength between the pressure barrier layer 130 and the composite layer 140 if the grooves are filled with a matrix. The matrix acts as a glue, causing the composite layer to be securely adhered to the underlying pressure barrier layer 130. Preferably, the grooves are helically oriented on the pressure barrier layer relative to the longitudinal axis 17.

FIG. 9 shows a “flattened out” view of a preferred composite layer 140 having a fiber component 120 interwoven with a plurality of like or different fiber components, here shown as a clockwise helically oriented fiber component 160 and a counterclockwise helically oriented fiber component 118. The configuration of layer 140 shown in FIG. 9, is appropriately denoted as a “triaxially braided” ply. The fiber components 160, 118, 120 are suspended in a matrix 122.

In another embodiment, axially extending structural fiber 120 is oriented relative to the longitudinal axis 17 at a first angle 128. Typically, fiber 120 is helically oriented at the first angle 128 relative to the longitudinal axis 17. The first angle 128 can vary between 5 degrees to 20 degrees, relative to the axis. The first angle 128 can also vary between 30 degrees to 70 degrees relative to the axis 17. Although it is preferred to have fiber 120 oriented at an angle of 45 degrees relative to axis 17.

The braiding fiber 160 is oriented relative to structural fiber 120 at a second angle 124, and braiding fiber 118 is oriented relative to structural fiber 120 at a third angle 126. The angle of braiding fibers 160 and 118, relative to structural fiber 120, may be varied between +/−10 degrees and +/−60 degrees. In one aspect, fibers 160 and 118 are oriented at an angle of +/−20 degrees relative to fiber 20.

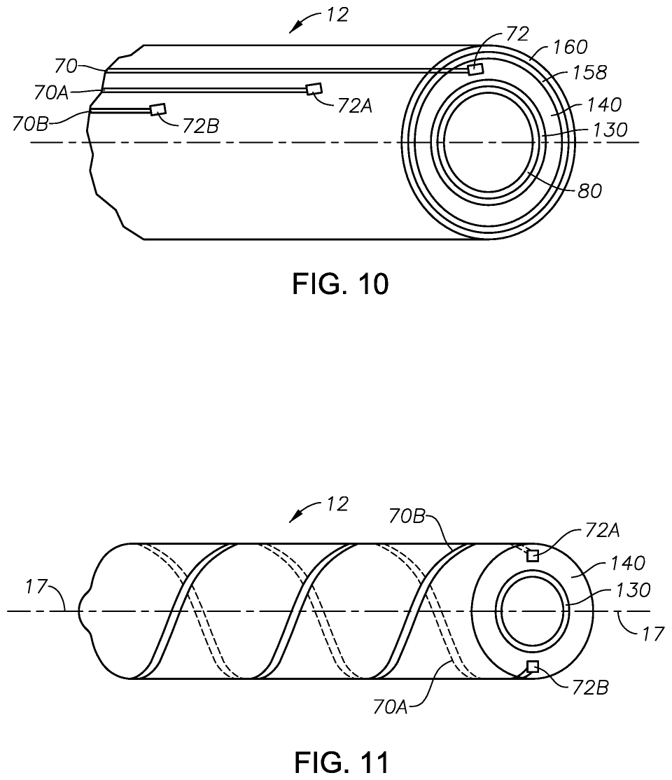

FIG. 10 illustrates an embodiment of the composite tubular member 12 having an inner protective layer 80, an inner pressure barrier layer 130, a composite layer 140, an outer pressure barrier 158, and an outer protective layer 160. An energy conductor 70 extends lengthwise along the tubular member and connects with a sensor 72. A second energy conductor 70A extends lengthwise along the tubular member and connects with a second sensor 72A. A third energy conductor 70B extends lengthwise along the tubular member and connects with a third sensor 72B.

As shown in FIG. 10, the tubular member 12 can include multiple sensors connected with multiple energy conductors. Each of the sensors can be located at different positions along the composite member 12. For instance, the sensors can be axially displaced, circumferentially displaced, or helically displaced from each other along the composite tubular member 12. The multiple sensors can each be separately connected to energy conductors as shown in FIG. 10. Multiple sensor form a matrix of sensors that span the composite tubular member. The matrix of sensors provides for increased accuracy in locating the position, relative to the tubular member, of the ambient condition being measured by the sensors.

As shown in FIG. 11, the energy conductors can be helically oriented relative to the longitudinal axis 17 of the composite tube to minimize the bending strain on the energy conductors. The composite tubular member 12 includes an inner pressure barrier layer 130, a composite layer 140, a first energy conductor 70A attached to a first sensor 72A, and a second energy conductor 70B attached to a second sensor 72B. The first energy conductor 70A and the second energy conductor 70B are wrapped around the tubular member 10 in opposite clockwise rotations.

The helical orientation of the energy conductors 70A, 70B allows the compression strain experienced by the section of the energy conductor located on the interior bend of the tube to be offset by the expansion strain experienced by the section of the conductor located on the exterior bend of the tube. That is, the conductor 70A, 70B is able to substantially distribute the opposing strains resulting from the bending action of the composite tube across the length of the conductor 70A, 70B, thereby reducing the damage to the energy conductor.

Another example embodiment is a method for monitoring a well condition. The method includes inserting a bottom hole assembly into a wellbore, and receiving, in real-time, data pertaining to the monitored well condition on the surface. The method further includes the steps of lowering the bottom hole assembly through a vertical part of the well, pushing the bottom hole assembly through a deviated part of the well using the tubing, and vibrating the bottom hole assembly and tubing with the vibrating tool to reduce friction between the bottom hole assembly and tubing, and the wellbore.

In some embodiments, the bottom hole assembly can include more than one vibrating tool. In addition, the method can include one or more of the steps of adjusting the distance of the bearing from the motor to increase or decrease vibration, and adjusting the weight of the bearing to increase or decrease vibration.

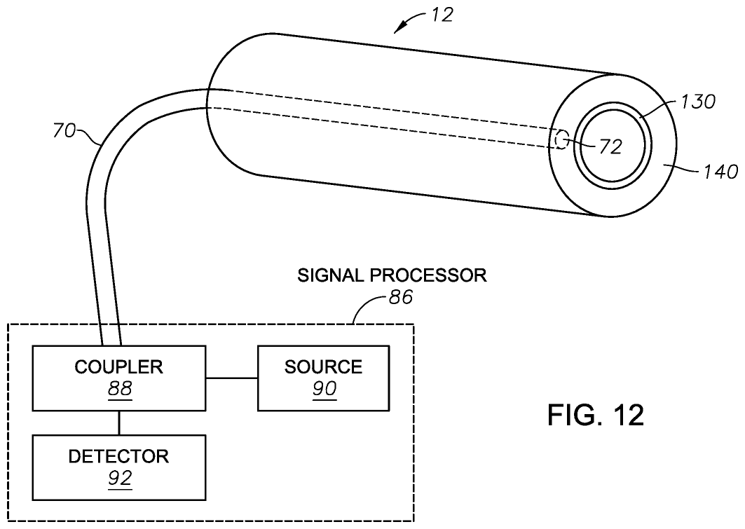

FIG. 12 illustrates a composite tubular member 12 having an energy conductor 70 connected to a signal processor 86. The energy conductor 70 is embedded within the composite tubular member 12. The signal processor is shown, in accordance with one aspect of this embodiment, as including an optional coupler 88, a source 90, and a detector 92. The signal processor can be positioned external to the composite tubular member 12, or the signal processor can be embedded within the composite tubular member.

The signal processor 86 receives data from the sensor 72 in the form of energy transmitted over the energy conductor 70. The signal processor then processes the received signal. The processing performed by the signal processing can include transforming the signal, filtering the signal, sampling the signal, or amplifying the signal. The operations performed by the signal processor 86 generally enhance the understanding of the signal transmitted over the energy conductor 70. For instance, the signal processor 86 can amplify and retransmit the signal over the energy conductor 70, i.e. the signal processor can act as a repeater circuit.

In another aspect, the signal processor can include a source 90 for transmitting an energy signal over the energy conductor 70, and a detector for receiving an energy signal from the energy conductor 92. The signal processor can also include an optional coupler 88 for interfacing or multiplexing the source 90 and the detector 92 with the energy conductor.

The energy signal transmitted by the source 90 is placed on the energy conductor 70 by the coupler 88. The energy signal reaches the sensor 72 and is modified by the interaction between the sensor 72 and the ambient conditions of the composite tubular member 12. The sensor transmits the modified energy signal over the energy conductor 70. The coupler 88 then interfaces the detector 90 with the energy conductor 70 so that the detector can identify the patterns in the modified energy signal. The detector determines the ambient conditions sensed by the detector 72 by comparing the properties of the energy signal transmitted by the source 90 with the properties of the modified energy signal.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A bottom hole assembly comprising:
a well logging tool including a plurality of sensors;
a vibrator tool coupled to the well logging tool, the vibrator tool configured to insert the well logging tool into a wellbore; and
a spoolable composite tube coupled to the vibrator tool, the spoolable composite tube configured to carry power and data cables from the surface to the plurality of sensors in the well logging tool.

2. The bottom hole assembly according to claim 1, wherein the well logging tool has a substantially cylindrical body comprising a matrix material.

3. The bottom hole assembly according to claim 1, wherein the plurality of sensors are selected from the group consisting of acoustic sensors, optical sensors, mechanical sensors, electrical sensors, fluidic sensors, pressure sensors, temperature sensors, and chemical sensors.

4. The bottom hole assembly according to claim 1, wherein the well logging tool further comprises one or more cameras installed on a distal end of the tool to provide a live visual means to check a well condition.

5. The bottom hole assembly according to claim 2, wherein the spoolable composite tube comprises a plurality of fibers embedded in the matrix material.

6. The bottom hole assembly according to claim 5, wherein the fibers are woven, braided, knitted, stitched, circumferentially wound, or helically wound.

7. The bottom hole assembly according to claim 5, wherein the fibers comprise at least one material selected from the group consisting of stainless steel, glass, carbon, ceramic, aramid, nylon, polyester, and polyethylene.

8. The bottom hole assembly according to claim 5, wherein the matrix material is selected from the group consisting of polyether ether ketone, polyether ketone, polyetherketoneketone, polyamide, polyethylene, polyurethane, polypropylene, polyphenylene sulfide, epoxy, phenolic, bismaleimide, ester, polyester, vinyl-ester, ceramic, and carbon.

9. The bottom hole assembly according to claim 5, wherein the power and data cables are at least partially encapsulated by the matrix material.

10. The bottom hole assembly according to claim 5, wherein the matrix material has a tensile modulus of elasticity of at least 250,000 psi, has a maximum tensile elongation of greater than or equal to 5%, or has a glass transition temperature of at least 180 degrees F.

11. The bottom hole assembly according to claim 1, wherein the vibrator tool further comprises:
a substantially cylindrical body;
a motor within the substantially cylindrical body;
a non-linear shaft attached to the motor so that as the motor turns the non-linear shaft, the non-linear shaft extends outwardly from the motor within the substantially cylindrical body; and
a bearing attached to the shaft a distance from the motor so that the bearing rotates as the non-linear shaft turns, the bearing contacting portions of the inner surface of the cylindrical body as the non-linear shaft turns, thereby vibrating the substantially cylindrical body.

12. The bottom hole assembly according to claim 11, wherein the motor turns the shaft at a rate of about 1000-2000 revolutions per minute.

13. The bottom hole assembly according to claim 11, wherein the substantially cylindrical body has longitudinal slots that are positioned to contact the bearing as the bearing rotates so that contact between the bearing and the slots amplifies the vibration of the vibrator tool.

14. A method for monitoring a well condition, the method comprising:
inserting a bottom hole assembly into a wellbore, the bottom hole assembly comprising:
a well logging tool including a plurality of sensors for monitoring a well condition;
a vibrator tool for enabling insertion of the well logging tool into the wellbore; and
a spoolable composite tube configured to carry power and data cables from the surface to the plurality of sensors in the well logging tool; and
receiving, in real-time, data pertaining to the monitored well condition on the surface.

15. A system for monitoring a well condition, the system comprising:
a well logging tool including a plurality of sensors;
a vibrator tool coupled to the well logging tool, the vibrator tool configured to insert the well logging tool into a wellbore; and
a spoolable composite tube coupled to the vibrator tool, the spoolable composite tube configured to carry power and data cables from the surface to the plurality of sensors in the well logging tool.

16. The system according to claim 15, wherein the well logging tool has a substantially cylindrical body comprising a matrix material.

17. The system according to claim 15, wherein the plurality of sensors are selected from the group consisting of acoustic sensors, optical sensors, mechanical sensors, electrical sensors, fluidic sensors, pressure sensors, temperature sensors, and chemical sensors.

18. The system according to claim 15, wherein the well logging tool further comprises one or more cameras installed on a distal end of the tool to provide a live visual means to check a well condition.

19. The system according to claim 16, wherein the spoolable composite tube comprises a plurality of fibers embedded in the matrix material.

20. The system according to claim 16, wherein the matrix material has a tensile modulus of elasticity of at least 250,000 psi, has a maximum tensile elongation of greater than or equal to 5%, or has a glass transition temperature of at least 180 degrees F.
